(19) United States
(12) Patent Application Publication
(10) Pub. No.: US 2003/0138593 A1
(43) Pub. Date: Jul. 24, 2003

(54) Removable device for inhibiting insects and possible foreign chemical entry into disposable beverage container

(76) Inventors: Anthony Lee Cox, Canton, GA (US); Evans Vincent Roberts JR., Canton, GA (US)

Correspondence Address: Anthony Lee Cox, 101 Rose Ridge Drive, Canton, GA, 30115, US

(21) Appl. No.: 10/340,931

(22) Filed: Jan. 13, 2003

Related U.S. Application Data
(60) Provisional application No. 60/350,621, filed on Jan. 24, 2002.

(51) Int. Cl. B32B 3/02

(52) U.S. Cl. 428/66.6; 428/66.3

(57) ABSTRACT

A device for the prevention of entry of flying and non-flying stinging insects into open disposable beverage containers. According to the embodiment, the device is manufactured out of flexible memory retentive plastic or rubber to allow for small variants in disposable beverage container diameters. The device incorporates several types of various openings of slotted, circular, elliptical, or geometrical shapes to allow for the free flow of the contained liquid. The device is capable of relief impressions and/or print ink application for advertising purposes. The device is capable of being installed and removed by the human hand. The device is reusable and is washable in both home and commercial dishwashing equipment.

Applicants hereby claims priority of Provisional Patent Application Ser. No. 60/350621 Dated Jan. 24, 2002

### FIELD OF INVENTION

This invention relates to the prevention of entry of flying and non-flying stinging insects into an open unattended disposable beverage container by utilizing a removable and reusable device, but would still allow for dispensing of the beverage contained in the container.

Additionally, this removable invention would possibly prevent the introduction of foreign or potentially harmful dry tablets or an encapsulated chemical compound into an open unattended disposable beverage container.

### BACKGROUND OF THE INVENTION

Every year hundreds of thousands of human beings are moving into rural areas of the country that were previously devoid of human presence. The introduction of humans and their unfamiliarity with hazards of rural country living has led to increasing number of individuals suffering from the involuntary ingestion of venous stinging insects of both the flying and non-flying variety from open unattended beverage containers. In addition, the suburban weekend cookout, the weekly round of golf, or the kids' day at the park exposes even a higher number of humans to the same hazards as those living in the country.

Yellow jackets, hornets, and wasps are drawn to the fragrances from naturally and artificially sweetened beverages, and the fermentation odor from alcoholic beverages such as beer. When these stinging insects enter a beverage container through the container's open dispensing port, the insect's presence generally goes undetected. Once the insect has entered the beverage container they are trapped inside yet very much still alive. The user of the beverage container will unwillingly ingest this living insect upon drinking the beverage. Upon ingestion by the human, the insect will react instinctively, which is to say, will sting the victim in an extremely sensitive portion of the human anatomy, most likely the inside of the mouth, the sides of the throat, or the gullet areas. While the stings of yellow jackets, hornets, or wasps can be quite painful and sometimes fatal when experienced on the skin of a human, this same sting in the highly sensitive mouth, throat, or gullet areas can be severe enough to cause death through toxic shock or suffocation through swelling of the windpipe.

### DESCRIPTION OF THE FIGURES

For the present invention to be understood, it will be described in conjunction with the aid of the following figures:

FIG. 1, the invention shows a pictorial of a snap on friction fit cap with intrinsic beverage dispensing slots which act as a protective screen to prevent the entry of flying and non-flying stinging insects while allowing for the free flow of liquids.

FIG. 2 depicts the friction fit retainer slots.

FIG. 3 depicts the top rim of a standard disposable beverage container.

FIG. 4 depicts the convex top of the invention.

FIG. 5 depicts the location of the liquid dispensing port of a disposable beverage container.

FIG. 6 depicts the pull-tab used for opening of the standard disposable beverage container.

FIG. 7 depicts the outside edge of the invention.

FIG. 8 depicts a standard disposable beverage container.

### DETAILED DESCRIPTION OF THE INVENTION

The invention (FIG. 1) is a removable and reusable plastic or rubber snap-on friction fitting cap with an intrinsic set of narrow slots (FIG. 5) of such minimal size to effectively act as a screen to prevent the passage of flying and non-flying venous (stinging) insects, but still allow for the free flow of the contained beverage.

The invention would be manufactured of a pliable flexible material such as plastic or rubber that will exhibit adequate elasticity and size retention to maintain a snug fit on a disposable beverage container top (FIG. 8) after repeated use.

The invention would be made of material that lends itself to normal cleaning and sanitizing methods employed in the average home or commercial kitchens today.

The invention would be lightweight and of such minimal material requirements that loss of the invention through handling damage, extended use, or entire physical loss would result in minimal financial loss.

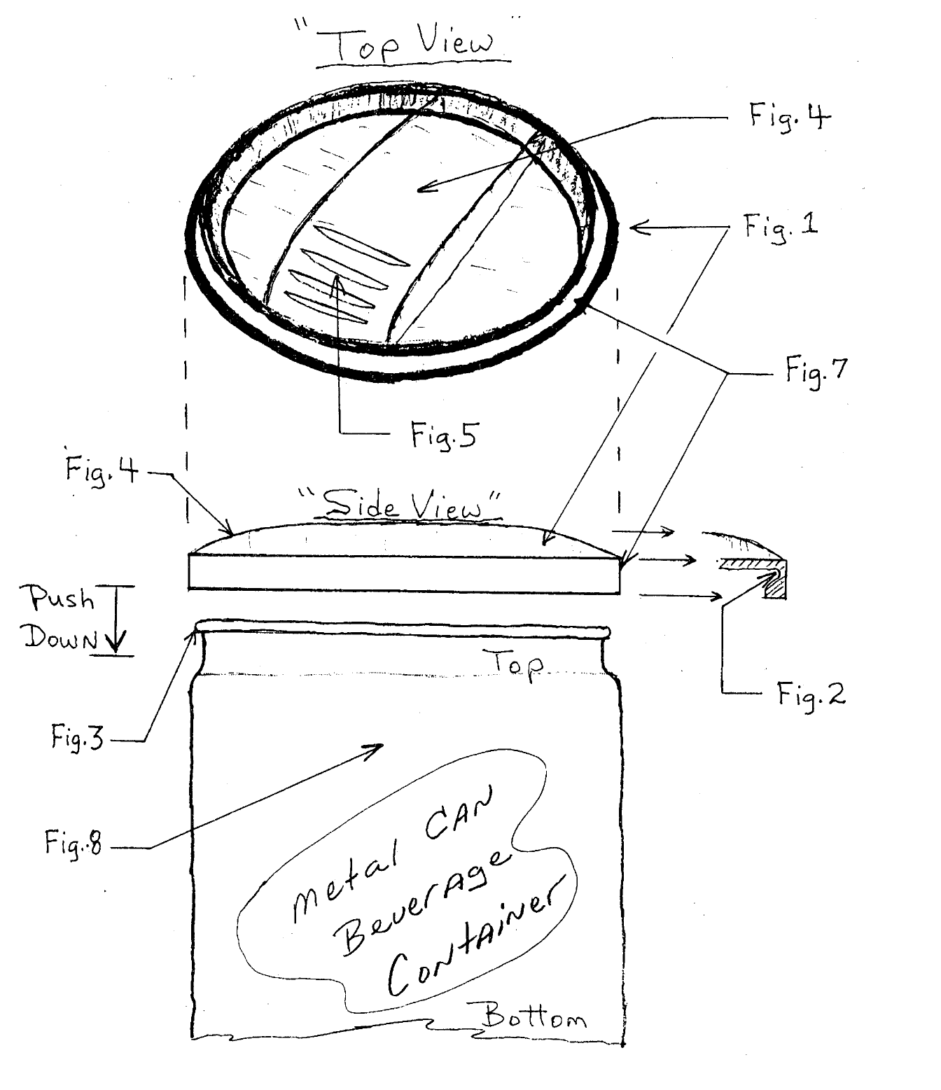

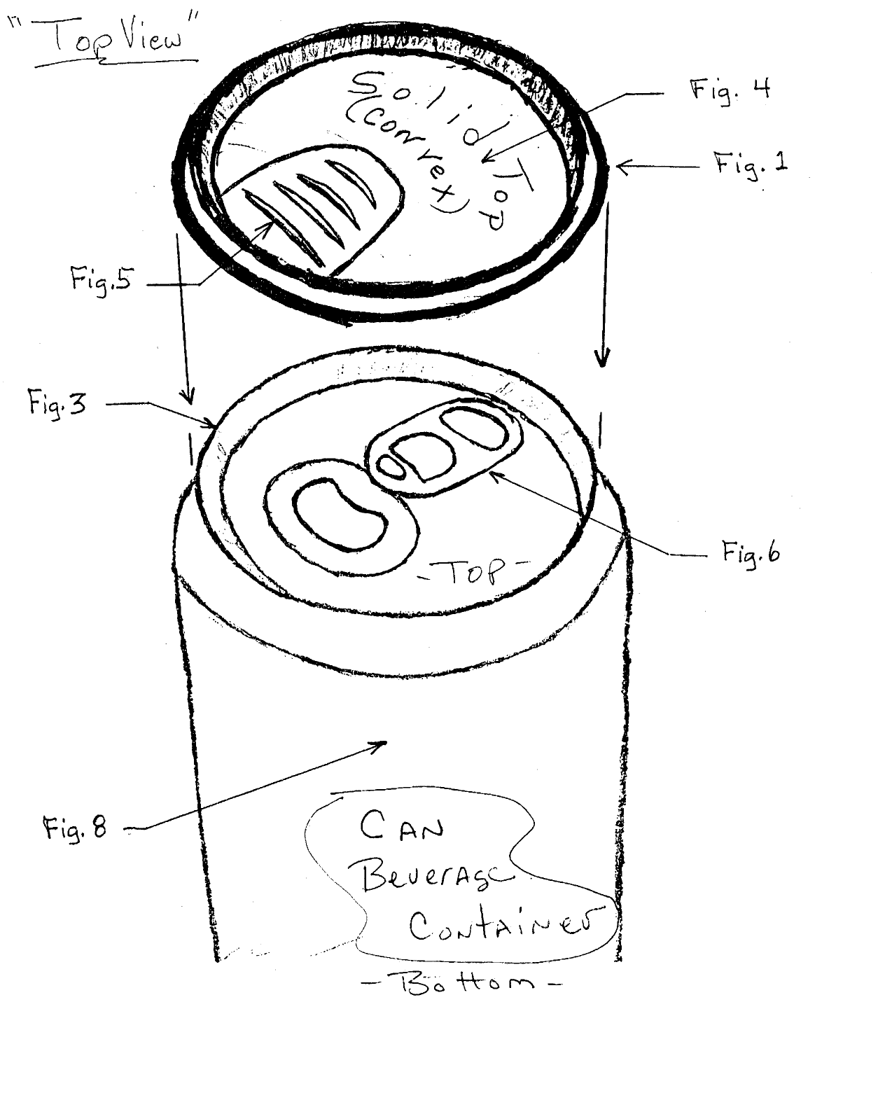

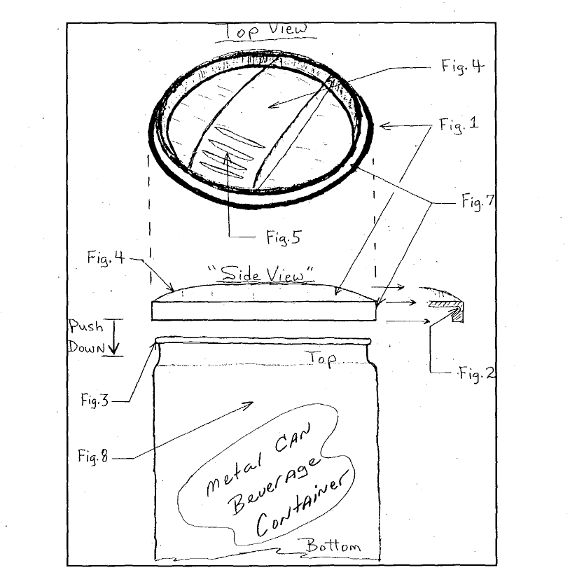

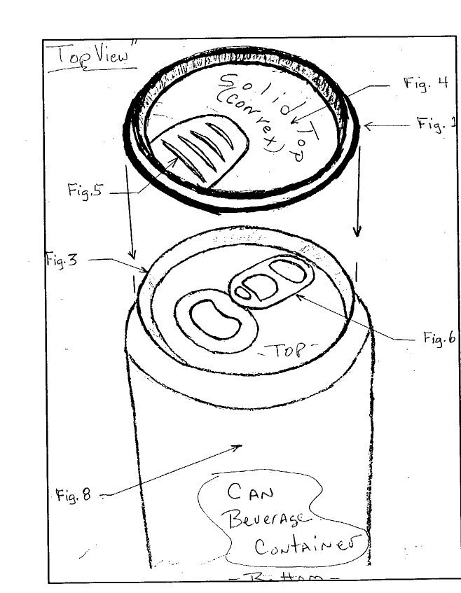

The invention would be employed by pressing it onto an open disposable beverage container top with minimal effort as supplied by a human hand. The invention can be removed for reuse by a similar reverse effort of the human hand. Upon application to a disposable beverage container, the invention would lock onto the container top as the friction retainer slot (FIG. 2) is pressed over the top rim (FIG. 3) of the container. The friction retainer slot (FIG. 2) is built into the 360 degree circular inside edge (FIG. 7) of the invention. The convex shaped design (FIG. 4) of the invention will provide adequate space for the beverage container pull-tab (FIG. 6) that normally remains attached to the beverage container top after opening. The invention would be capable of receiving relief impressions or print ink for advertising purposes (FIG. 4).

What is claimed is:

1. A device designed to prevent the entry of flying and non-flying stinging insects into open disposable beverage containers and is compromised of:
a removable and reusable snap-on friction fit cap made of plastic with sufficient elasticity and size retention properties for repeated reuse.

2. The invention of claim 1, can be manufactured from rubber.

3. The invention of claim 1, is self-adjusting in size to accommodate small variants in the top diameter of disposable beverage containers.

4. The invention of claim 1, is washable in normal home and restaurant kitchens.

5. The invention of claim 1, is lightweight and non-toxic.

6. The invention of claim 1, is durable.

7. The invention of claim 1, is capable of name branding through relief impressions for such items as corporate logos, trademarks, or service marks for advertising purposes.

8. The invention of claim 1, is capable of name branding through the application of print ink for such items as corporate logos, trademarks, or service marks for advertising purposes.

9. The invention of claim 1, is capable of being manufactured in all colors.

10. The invention of claim 1, has a convex shaped area on the top to allow for the presence of the pull-tab of disposable beverage container.

11. The invention of claim 1, has various sized slots to allow for the free flow of liquid through it but prevent the passage of flying and non-flying stinging insects.

12. The invention of claim 1, has various sized circular holes to allow for the free flow of liquid through it but prevent the passage of flying and non-flying stinging insects.

13. The invention of claim 1, has various sized geometrical shaped openings to allow for the free flow of liquid through it but prevent the passage of flying and non-flying stinging insects.

14. The invention of claim 1, has various elliptical sized openings to allow for the free flow of liquid through it but prevent the passage of flying and non-flying stinging insects.
